(19) United States
(12) Patent Application Publication
(10) Pub. No.: US 2006/0170406 A1
(43) Pub. Date: Aug. 3, 2006

(54) Hall element and manufacturing method thereof

(75) Inventors: Takashi Kawashima, Nagoya-city (JP); Yasuaki Makino, Okazaki-city (JP); Masato Ishihara, Anjo-city (JP); Yukiaki Yogo, Okazaki-city (JP); Satoshi Oohira, Gifu-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/340,545

(22) Filed: Jan. 27, 2006

(30) Foreign Application Priority Data
Jan. 28, 2005 (JP) 2005-22164

(51) Int. Cl. G05F 1/635

(52) U.S. Cl. 323/294; 323/368

(57) ABSTRACT

An N-type epitaxial layer is formed on a p-type silicon substrate. Four N⁺ regions (diffusion regions used as electrodes) are formed in the N-type epitaxial layer. An insulation layer having a fixed depth is formed around each of the N⁺ regions on a principal surface of an epitaxial layer. The insulation layer restricts a current path region formed between the N⁺ regions. Side surfaces of the N⁺ regions are covered by the insulation layer. The N⁺ regions are brought into contact with the epitaxial layer by a bottom surface exposed from the insulation layer.

### CROSS REFERENCE TO RELATED APPLICATION

This application is based upon, claims the benefit of priority of, and incorporates by reference the contents of Japanese Patent Application No. 2005-22164 filed on Jan. 28, 2005.

### TECHNICAL FIELD

The technical field relates to a hall element and a manufacturing method for the hall element.

### BACKGROUND

Hall elements are known as magnetoelectric conversion elements that can be integrated. One such type is a vertical hall element disclosed in, for example, JP-A-4-26170. The vertical hall element is designed so that current flows in the thickness direction of a semiconductor substrate. Specifically, a current passage is formed between an N⁺-region formed on the surface of an N-type epitaxial layer on a P-type silicon substrate and an N⁺-buried region buried at a predetermined depth, and a hall voltage occurring when a magnetic field acts in parallel to the surface of the substrate is detected by a pair of N⁺-regions formed on the surface of the N-type epitaxial layer. Furthermore, in the above publication, a channel region is formed between trenches formed in the substrate, current is made to flow in the region defined by the trenches formed, and a high concentration diffusion layer formed along the bottom portion of the trenches is set as a hall voltage detection region, thereby enhancing the sensitivity.

However, with respect to the hall element described in the above publication, the diffusion region (hall voltage detecting region) is formed along the trench bottom portion, so that the structure is complicated and it is an obstruction to further enhancement of the sensitivity. In addition, the manufacturing process is also complicated (specifically, it is necessary to carry out two-stage epitaxial growth, etc., which causes complication).

### SUMMARY

It is an object to provide a hall element having a novel construction and excellent sensitivity, and a method of manufacturing the hall element.

According to a first aspect, a hall element includes an insulating layer having a predetermined depth that is formed around a diffusion region for a second electrode, around a diffusion region for a third electrode and around a diffusion region for a fourth electrode on the principal surface a semiconductor substrate, wherein the insulating layer regulates a current passage region formed between the first electrode diffusion region and the second electrode diffusion region, the side surfaces of the third and fourth electrode diffusion regions are covered by the insulating layer, and the bottom surfaces thereof exposed from the insulating layer are brought into contact with the semiconductor substrate.

According to the first aspect, the current passage region formed between the first electrode diffusion region and the second electrode diffusion region is regulated by the insulating layer, whereby the current passage region is prevented from spreading, and thus diffusion of electrons is suppressed to thereby enhance current density. Furthermore, the side surfaces of the third and fourth electrode diffusion regions are coated by the insulating layer, and the bottom surfaces thereof exposed from the insulating layer are brought into contact with the semiconductor substrate, whereby the contact position (the position of the bottom surfaces of the diffusion regions) can be easily adjusted to suitable positions. Therefore, when a hall voltage is detected in the third and fourth electrode diffusion regions, the symmetry of the resistance component (balance of Wheatstone bridge) in the current passage region (magnetic detector) can be enhanced. As described above, the sensitivity of the hall element can be enhanced.

According to a second aspect, in the hall element of the first aspect, it is preferable that the insulating layer, the third electrode diffusion region and the fourth electrode diffusion region are formed so as to be deeper than the second electrode diffusion region, whereby the symmetry of the resistance component (balance of Wheatstone bridge) in the current passage region (magnetic detector) can be enhanced.

According to a third aspect, a diffusion region having the opposite conductivity type to that of the semiconductor substrate is formed at a predetermined depth around the second electrode diffusion region on the principal surface of the semiconductor substrate to regulate a current passage region formed between the first electrode diffusion region and the second electrode diffusion region by the diffusion region, and an insulating layer for regulating the current passage region is buried in a deeper site than the diffusion region having the opposite conductivity type in the semiconductor substrate.

According to a third aspect, a current passage region formed between a diffusion region for a first electrode and a diffusion region for a second electrode is regulated by a diffusion region having the opposite conductivity type to that of a semiconductor substrate, whereby the current passage region can be prevented from spreading and thus diffusion of electrons is suppressed. Furthermore, by regulating the current passage region by a buried insulating layer, spreading of the current passage region is prevented, and diffusion of electrodes is suppressed, whereby current density is increased and the sensitivity of the hall element can be enhanced.

According to a fourth aspect, in the hall element of any one of the first to third aspects, the distance between the first electrode diffusion region and the second electrode diffusion region is set to be equal to the distance between the third electrode diffusion region and the fourth electrode diffusion region.

According to the fourth aspect, when a chopper driving operation is carried out so as to repeat a state where current is made to flow between the first electrode diffusion region and the second electrode diffusion region and a hall voltage is detected by the third electrode diffusion region and the fourth electrode diffusion region and a state where current is made to flow between the third electrode diffusion region and the fourth electrode diffusion region and also a hall voltage is detected by the first electrode diffusion region and the second electrode diffusion region, the distance between the current electrodes is equal to the distance between the voltage electrodes, and thus an offset cancel effect can be more efficiently achieved.

According to a fifth aspect, a method of manufacturing a hall element of the first aspect comprises: a first step of forming, on a semiconductor substrate serving as a base substrate, an epitaxial layer serving as a semiconductor substrate having the opposite conductivity type to that of the semiconductor substrate under a state that a first electrode diffusion region is buried at an interface portion; a second step of forming insulating-layer burying trenches around each formation-planed site of a second electrode diffusion region, a third electrode diffusion region and a fourth electrode diffusion region on the principal surface of the epitaxial layer; a third step of burying an insulating layer in the insulating-layer burying trenches; and a fourth step of forming a third electrode diffusion region and a fourth electrode diffusion region in the epitaxial layer so that the side surfaces of the third and fourth electrode diffusion regions are brought into contact with the insulating layer and also forming a second electrode diffusion region. In the fourth step, by adjusting the depth of the third electrode diffusion region and the fourth electrode diffusion region, the position of the contact with the semiconductor substrate at the bottom surface exposed from the insulating layer (the position of the bottom surface of the diffusion region) can be adjusted. As described above, when a hall voltage is detected in the third and fourth electrode diffusion regions by adjusting the contact position (the position of the bottom surface of the diffusion region), the symmetry of the resistance component (balance of Wheatstone bridge) in a current passage region (magnetic detector) formed between the first electrode diffusion region and the second electrode diffusion region can be enhanced. Furthermore, according to this manufacturing method, an insulating layer for regulating the current passage region can be disposed.

Furthermore, according to a sixth aspect, a method of manufacturing a hall element of the first aspect comprises: a first step of forming a first electrode diffusion region on the surface of a semiconductor substrate; a second step of attaching through oxide film a base substrate and the surface of the semiconductor substrate on which the first electrode diffusion region is formed; a third step of polishing the principal surface of the semiconductor substrate and thinning the semiconductor substrate; a fourth step of forming insulating-layer burying trenches around each formation-planed site of the second electrode diffusion region, the third electrode diffusion region and the fourth electrode diffusion region on the principal surface of the semiconductor substrate; a fifth step of burying an insulating layer in the insulating-layer burying trenches; and a sixth step of forming the third electrode diffusion region and the fourth electrode diffusion region so that the side surfaces thereof are brought into contact with the insulating layer. In the sixth step, by adjusting the depth of the third electrode diffusion region and the fourth electrode diffusion region, the contact position with the semiconductor substrate at the bottom surface exposed from the insulating layer (the position of the bottom surface of the diffusion region) can be adjusted. When a hall voltage is detected at the third and fourth electrode diffusion regions, by adjusting the contact position (the position of the bottom surface of the diffusion region) as described above, the symmetry of the resistance component (balance of wheatstone bridge) in a current passage region (magnetic detector) formed between the first electrode diffusion region and the second electrode diffusion region can be enhanced. Furthermore, according to this manufacturing method, the insulating layer for regulating the current passage region can be disposed.

According to a seventh aspect, a method of manufacturing a hall element of the third aspect comprises: a first step of forming a first electrode diffusion region on the surface of a semiconductor substrate; a second step of forming a trench around a site serving as a current passage region formed between a first electrode diffusion region and a second electrode diffusion region on the opposite surface to a surface of the semiconductor substrate on which the first electrode diffusion region is formed; a third step of depositing an insulating layer on the semiconductor substrate to fill the trench with the insulating layer; a fourth step of polishing the insulating layer to expose the semiconductor substrate; a fifth step of forming an epitaxial layer on the semiconductor substrate; and a sixth step of forming, on the principal surface of the epitaxial layer, the second electrode diffusion region, a third electrode diffusion region, a fourth electrode diffusion region and a diffusion region around the second electrode diffusion region, the diffusion region having the opposite conductivity type to that of the epitaxial layer and regulating the current passage region. According to this manufacturing method, the insulating layer and the diffusion layer (the diffusion region having the opposite conductivity type to that of the epitaxial layer) for regulating the current passage region can be disposed.

### BRIEF DESCRIPTION OF THE DRAWINGS

FIG. 1 is a plan view showing a place where a hall element of a hall IC according to a first embodiment is formed;

FIG. 2 is a cross-sectional view taken along II-II of FIG. 1;

FIG. 3 is a cross-sectional view taken along III-III of FIG. 1;

FIG. 4 is a perspective view at the cross section of II-II of FIG. 1;

FIG. 5 is a diagram showing the electrical construction of the hall IC of the embodiment;

FIG. 6 is a longitudinally sectional view showing a manufacturing process of the first embodiment;

FIG. 7 is a longitudinally sectional view showing the manufacturing process of the first embodiment;

FIG. 8 is a longitudinally sectional view showing the manufacturing process of the first embodiment;

FIG. 9 is a longitudinally sectional view showing the manufacturing process of the first embodiment;

FIG. 10 is a longitudinally sectional view showing the manufacturing process of the first embodiment;

FIG. 11 is a longitudinally sectional view showing the manufacturing process of the first embodiment;

FIG. 12 is a plan view showing a place where a hall element of a hall IC according to a second embodiment is formed;

FIG. 13 is a cross-sectional view taken along XIII-XIII of FIG. 12;

FIG. 14 is a cross-sectional view taken along XIV-XIV of FIG. 12;

FIG. 15 is a longitudinally sectional view showing a manufacturing process of the second embodiment;

FIG. 16 is a longitudinally sectional view showing the manufacturing process of the second embodiment;

FIG. 17 is a longitudinally sectional view showing the manufacturing process of the second embodiment;

FIG. 18 is a longitudinally sectional view showing the manufacturing process of the second embodiment;

FIG. 19 is a longitudinally sectional view showing the manufacturing process of the second embodiment;

FIG. 20 is a longitudinally sectional view showing the manufacturing process of the second embodiment;

FIG. 21 is a longitudinally sectional view showing the manufacturing process of the second embodiment;

FIG. 22 is a plan view showing a place where a hall element of a hall IC of a third embodiment is formed;

FIG. 23 is a cross-sectional view taken along XXIII-XXIII of FIG. 22;

FIG. 24 is a cross-sectional view taken along XXIV-XXIV of FIG. 22;

FIG. 25 is a perspective view at the cross section XXIII-XXIII of FIG. 22;

FIG. 26 is a longitudinally sectional view showing a manufacturing step of the third embodiment;

FIG. 27 is a longitudinally sectional view showing the manufacturing step of the third embodiment;

FIG. 28 is a longitudinally sectional view showing the manufacturing step of the third embodiment;

FIG. 29 is a longitudinally sectional view showing the manufacturing step of the third embodiment;

FIG. 30 is a longitudinally sectional view showing the manufacturing step of the third embodiment;

FIG. 31 is a longitudinally sectional view showing the manufacturing step of the third embodiment; and

FIG. 32 is a longitudinally sectional view showing the manufacturing step of the third embodiment.

### DETAILED DESCRIPTION OF THE PREFERRED EMBODIMENTS

Preferred embodiments will be described hereunder with reference to the accompanying drawings.

### First Embodiment

A first embodiment will be described with reference to the accompanying drawings.

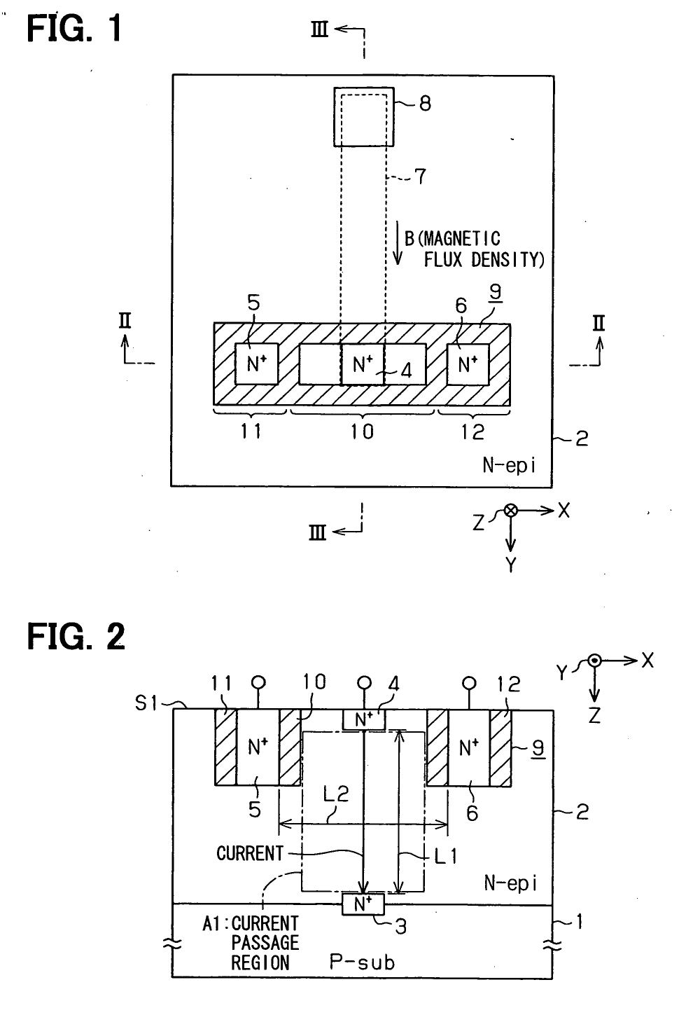

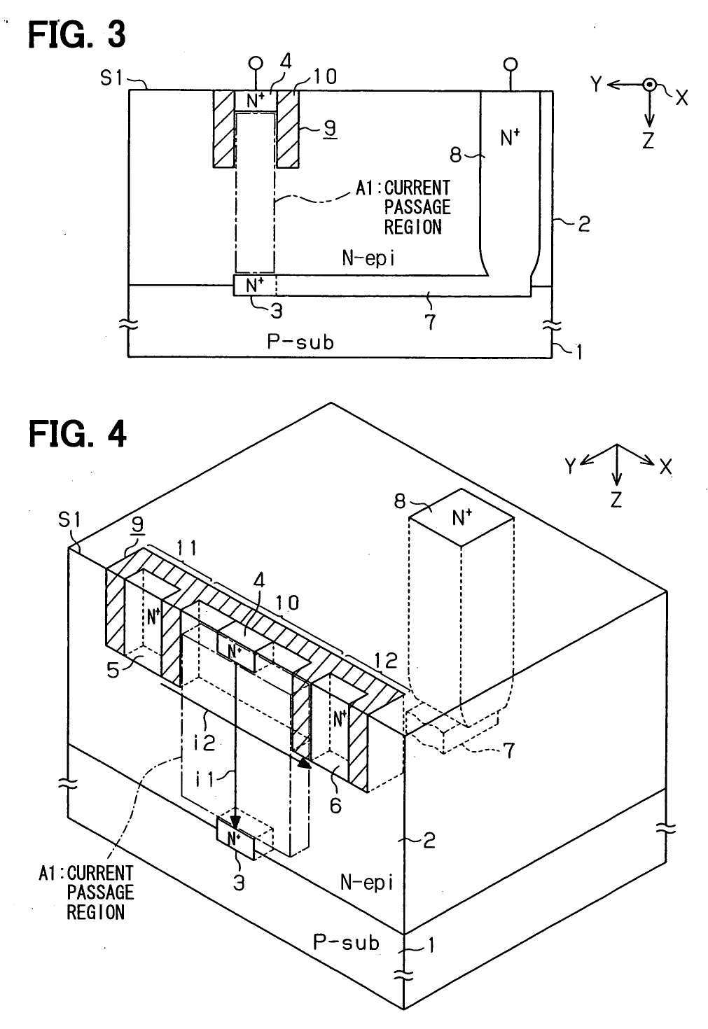

FIG. 1 is a plan view at a place where a hall element of a hall IC of this embodiment is formed. FIG. 2 is a cross-sectional view taken along II-II of FIG. 1, and FIG. 3 is a cross-sectional view taken along III-III of FIG. 1. FIG. 4 is a perspective view at the cross section of II-II of FIG. 1.

As the three-axis orthogonal coordinate system, the axes perpendicular to each other in the plan direction of the substrate are set to X-axis and Y-axis, and also the axis in the thickness direction of the substrate is set to Z-axis. The hall element of this embodiment is an element for detecting magnetic flux density B acting in the Y-axis direction of the plan direction of the substrate. In a hall IC, the hall element and a circuit for subjecting the output of the hall element to amplification, operation, etc. are integrated in the same chip as the hall element.

An N-type epitaxial layer 2 is formed on a P-type silicon substrate 1. N⁺-regions 3, 4, 5, and 6 are formed as four electrode diffusion regions in the N-type epitaxial layer 2 as a semiconductor substrate.

Specifically, a buried N⁺-region 3 is formed at the interface portion between the N-type epitaxial layer 2 and the P-type silicon substrate 1. That is, the N⁺-region 3 as a first electrode diffusion region is formed at a predetermined depth position from the principal surface S1 of the N-type epitaxial layer 2. Furthermore, an N⁺-region 4 as a second electrode diffusion region is formed on the principal surface S1 corresponding to the upper surface of the N-type epitaxial layer 2. The N⁺-region 4 and the buried N⁺-region 3 are formed so as to be overlapped with each other in the Z-axis direction (in the thickness direction of the substrate). The N⁺-region 4 and the buried N⁺-region 3 are designed to have the same shape and the same dimension. Furthermore, an N⁺-region 5 as a third electrode diffusion region and an N⁺-region 6 as a fourth electrode diffusion region are formed on the principal surface S1 of the N-type epitaxial layer 2 so as to sandwich the N⁺-region 4 therebetween. The N⁺-regions 4, 5, and 6 are juxtaposed with one another in the right-and-left direction (X-axis direction) so as to be spaced from one another, and the N⁺-region 5 and the N⁺-region 6 are disposed to be positionally symmetrical with each other with respect to the N⁺-region 4.

As shown in FIG. 3, a buried N⁺-region 7 as a wire is formed so as to extend from the buried N⁺-region 3 along the interface portion between the P-type silicon substrate 1 and the N-type epitaxial layer 2. Furthermore, an N⁺-region 8 as a wire is formed so as to extend in the thickness direction of the N-type epitaxial layer 2 at the end portion of the buried N⁺-region 7, and the N⁺-region 8 is exposed to the surface of the N-type epitaxial layer 2, thereby allowing the electrical connection to the buried N⁺-region 3 through the N⁺-regions 7, 8.

Furthermore, an insulating layer 9 is formed around the N⁺-region 4, around the N⁺-region 5 and around the N⁺-region 6 on the upper surface (principal surface S1) of the N-type epitaxial layer 2. Silicon oxide film is used as the insulating layer 9. The insulating layer 9 is designed to have such a planar shape that three rectangular frames are arranged in the right-and-left direction as shown in FIG. 1. That is, the three rectangular frame portions 10, 11 and 12 are juxtaposed with one another so as to come into contact with one another in the X-axis direction. The center rectangular frame portion 10 is designed as an oblong having longer sides in the right-and-left direction, and the N⁺-region 4 is located at the center portion in the right-and-left direction of FIG. 1.

The rectangular frame portion 11 at the left side in FIG. 1 has a square shape, and comes into contact with the side surface of the N⁺-region 5. Furthermore, the rectangular frame portion 12 at the right side has a square shape, and comes into contact with the side surface of the N⁺-region 6. The insulating layer 9 (rectangular frame portions 10, 11, and 12) is formed at a predetermined depth from the upper surface of the N-type epitaxial layer 2 as shown in FIGS. 2 and 3, and it is formed at a deeper position than the N⁺-region 4.

The N⁺-region 5 is formed at a deeper position than the N⁺-region 4, and it is formed at the same depth as the insulating layer 9 (rectangular frame portion 11). Likewise, the N⁺-region 6 is formed at a deeper position than the N⁺-region 4, and also it is formed at the same depth as the insulating layer 9 (rectangular frame portion 12).

As described above, the side surfaces of the N⁺-regions 5, 6 are in contact with the insulating layer 9 (rectangular frame portions 11, 12), and only the bottom surfaces thereof are in contact with the N-type epitaxial layer 2. Accordingly, the bottom surfaces of the N⁺-regions 5, 6 for electrodes serve as contact portions, and the positions of the contact portions can be suitably adjusted by adjusting the depth of the N⁺-regions 5, 6.

As shown in FIGS. 2, 3, when current is made to flow between the N⁺-region 4 formed on the upper surface (main surface S1) of the epitaxial layer 2 and the buried N⁺-region 3 buried in the epitaxial layer 2, a current passage region A1 through which the current flows is as follows. That is, the current passage region A1 is formed in an area that is surrounded by the rectangular frame portion 10 of the insulating layer and located below the area concerned. That is, the current passage region A1 formed between the N⁺-region 3 and the N⁺-region 4 is regulated by the insulating layer 9 having the predetermined depth which is formed around the N⁺-region 4 on the principal surface S1 of the epitaxial layer 2 as shown in FIG. 4. Accordingly, spreading of the current passage region A1 can be prevented, and diffusion of electrons can be suppressed. As a result, the current density is enhanced, and the sensitivity of the hall element is enhanced.

Furthermore, as shown in FIG. 4, the side surfaces of the N⁺-region 5 and the N⁺-region 6 are coated by the insulating layer 9 having the predetermined depth (the rectangular frame portions 11, 12) formed around the N⁺-region 5 and around the N⁺-region 6 on the principal surface S1 of the epitaxial layer 2, and the N⁺-region 5 and the N⁺-region 6 are in contact with the N-type epitaxial layer 2 at the bottom surfaces thereof exposed from the insulating layer 9. Accordingly, the contact positions (the positions of the bottom surfaces of the N⁺-regions 5 and 6) can be easily adjusted to suitable positions, and the symmetry of the resistance component (the balance of the wheatstone bridge) in the current passage region (magnetic detector) A1 can be enhanced when the hall voltage is detected by the N⁺-regions 5, 6. Accordingly, an offset voltage can be suppressed from being deviated, and the sensitivity of the hall element can be enhanced. Particularly, if the insulating layer 9 and the N⁺-regions 5 and 6 are formed to be deeper than the N⁺-region 4, it is preferable because the symmetry of the resistance component (the balance of the wheatstone bridge) in the current passage region (magnetic detector) A1 can be enhanced. Furthermore, the deeper N⁺-regions 5 and 6 can be disposed in narrow areas. As a result, the occupational area of the hall element can be reduced, and thus the hall element can be miniaturized.

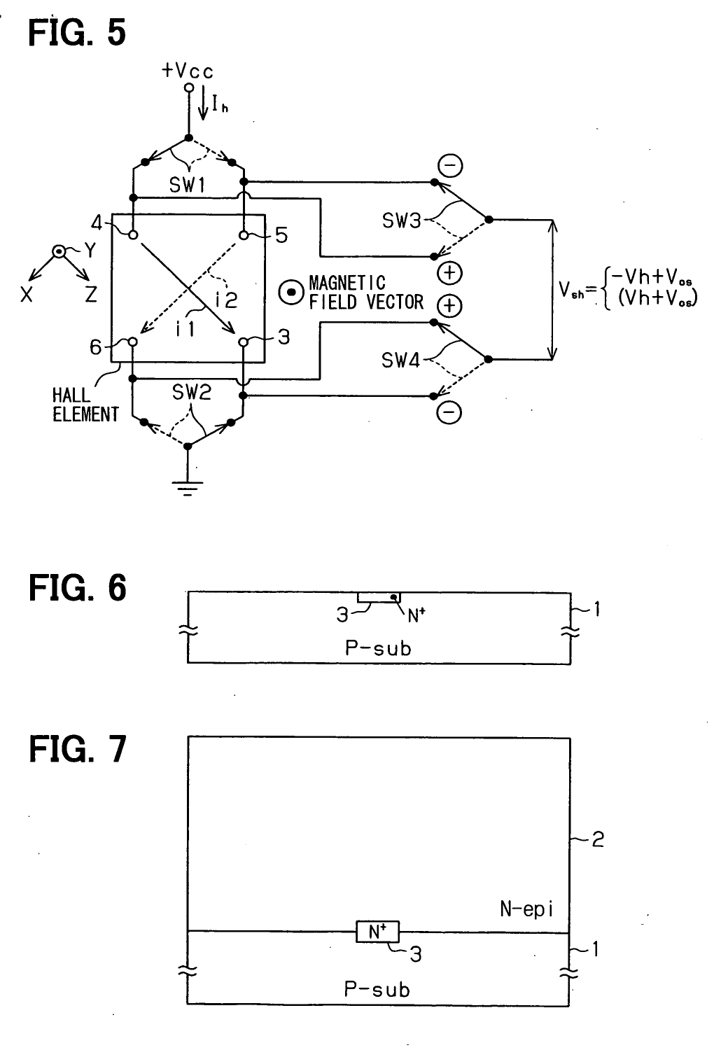

FIG. 5 shows the electrical construction of the hall IC according to this embodiment, and also shows the constructions of the hall element and the peripheral circuit thereof.

In FIG. 5, the hall element has the N⁺-regions 3, 4, 5 and 6 as four electrodes. A switching switch SW1 is disposed between each of the N⁺-regions 4, 5 and a plus-side power source terminal Vcc. Furthermore, a switching switch SW2 is disposed between each of the N⁺-regions 3, 6 and the ground terminal. A switching switch SW3 is disposed between each of the N⁺-regions 4, 5 and one hall voltage detecting terminal. Furthermore a switching switch SW4 is disposed between each of the N⁺-regions 3, 6 and the other hall voltage detecting terminal.

Under a first state, the switching switches SW1, SW2, SW3, and SW4 are set to the positions as indicated by solid lines in FIG. 5, so that hall current flows between the N⁺-regions 3 and 4 and a hall voltage occurring between the N⁺-regions 5 and 6 is detected. Under a second state, the switching switches SW1, SW2, SW3, and SW4 are set to positions indicated by broken lines in FIG. 5, so that hall current i2 flows between the N⁺-regions 5 and 6 and a hall voltage occurring between the N⁺-regions 3 and 4 is detected. With respect to the hall voltage under the first state, the N⁺-region 5 serves as a minus side, and the N⁺-region 6 serves as a plus side. Furthermore, with respect to the hall voltage under the second state, the N⁺-region 4 serves as a plus side, and the N⁺-region 3 serves as a minus side.

By carrying out measurements while alternately repeating the first and second states, the offset can be canceled. This will be described in detail as follows.

Under the first state, the output voltage Vsh is represented as follows:
Vsh=−Vh+Vos
Vh represents a hall voltage, and Vos represents an offset voltage.

Under the second state, the output voltage Vsh′ is represented as follows:
Vsh′=Vh+Vos
Vh represents the hall voltage, and Vos represents the offset voltage.

Accordingly, the difference of the output voltages (Vsh′−Vsh) is represented as follows:
Vsh′−Vsh=2Vh
Vh=(Vsh′−Vsh)/2
Therefore, the offset voltage Vos can be canceled.

As described above, according to this embodiment, when a chopping driving operation is carried out, as shown in FIG. 2, the distance L1 between the N⁺-region 3 and the N⁺-region 4 is equal to the distance L2 between the N⁺-region 5 and the N⁺-region 6 (L1=L2). More specifically, the distance L1 between the confronting faces of the N⁺-regions 3 and 4 is equal to the minimum distance L2 between the bottom surface of the N⁺-region 5 and the bottom surface of the N⁺-region 6. Accordingly, the distance between the current electrodes is equal to the distance between the voltage electrodes, and the offset cancel effect based on the chopper driving operation can be more efficiently achieved.

Next, a manufacturing method will be described with reference to FIGS. 6 to 11. FIGS. 6 to 11 are longitudinally sectional views of the site corresponding to FIG. 2 (II-II of FIG. 1).

First, as shown in FIG. 6, the P-type silicon substrate 1 is prepared. The P-type silicon substrate 1 is a semiconductor substrate serving as a base substrate. The N⁺-region 3 and the N⁺-region 7 (see FIG. 3) are formed on the upper surface of the P-type silicon substrate 1. Furthermore, as shown in FIG. 7, the N-type epitaxial layer (the epitaxial layer serving as the semiconductor substrate having the opposite conductivity type to that of the substrate 1) 2 is formed on the P-type silicon substrate 1 while the N⁺-region 3 is buried at the interface portion (first step).

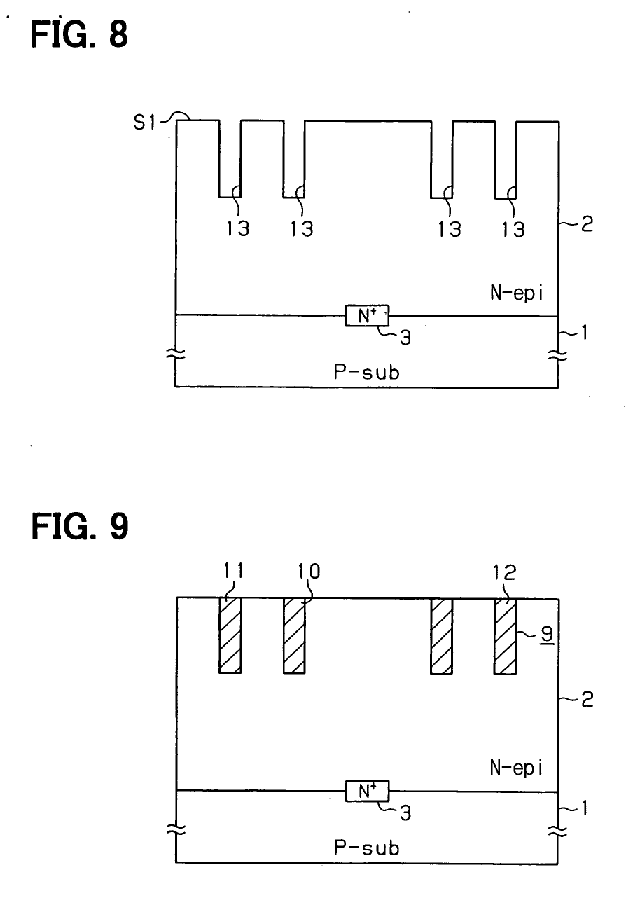

Furthermore, as shown in FIG. 8, insulating layer burying trenches 13 are formed at the arrangement area of the insulating layer 9 in FIG. 1, that is, around each formation-planed site of the N⁺-region 4, the N⁺-region 5 and the N⁺-region 6 on the principal surface S1 of the epitaxial layer 2 (second step). Then, as shown in FIG. 9, the insulating layer of SiO₂ (rectangular frame portions 10, 11, and 12) is buried in the trenches 13 (third step). Thereafter, the surface of the N-type epitaxial layer 2 is flattened.

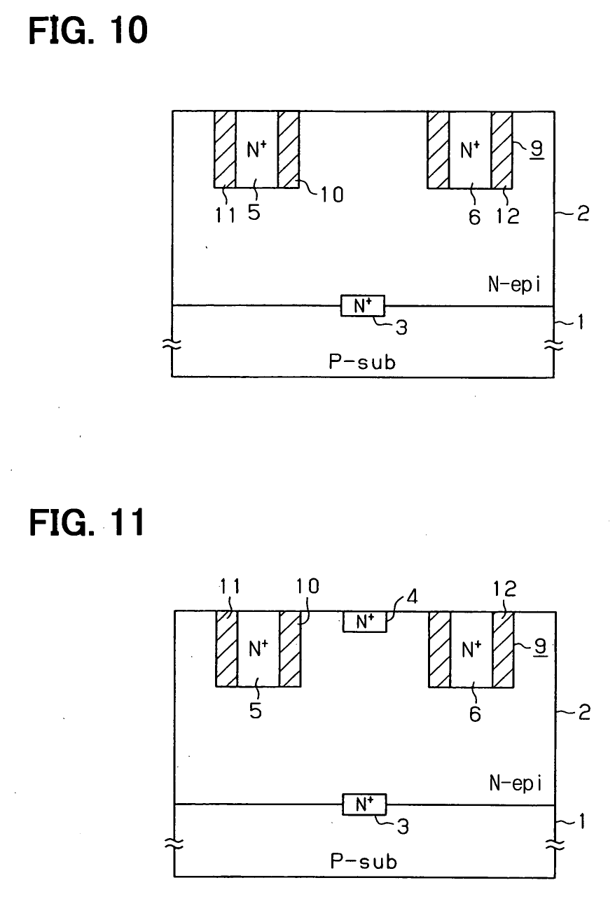

Subsequently, as shown in FIGS. 10 and 11, the N⁺-region 5 and the N⁺-region 6 are formed in the epitaxial layer 2 so that the side surfaces thereof are in contact with the insulating layer 9, and also the N⁺-region 4 is formed (fourth step). Specifically, as shown in FIG. 10, the N⁺-regions 5, 6 are formed at the same depth as the rectangular frame portions 11, 12 by, for example, conducting ion-implantation on the surface portion of the area surrounded by the rectangular frame portions 11, 12 in the epitaxial layer 2. Furthermore, as shown in FIG. 11, the N⁺-region 4 is formed by, for example, conducting ion-implantation on the surface portion of the area surrounded by the rectangular frame portion 10 in the epitaxial layer 2. In FIGS. 10 and 11, the N⁺-region regions 5, 6 are formed to be deeper than the N⁺-region 4. Furthermore, the N⁺-region 8 shown in FIG. 3 is also formed.

Here, the depths of the N⁺-regions 5, 6 can be set to suitable values by adjusting the ion-implantation energy when the N⁺-regions 5, 6 are formed. That is, by adjusting the depths of the N⁺-regions 5, 6, the positions of the N⁺-regions 5, 6 with the N-type epitaxial layer 2 at the bottom surfaces exposed from the insulating layer 9 (the positions of the bottom surfaces of the N⁺-regions 5, 6) can be adjusted. As described above, when the contact positions (the positions of the bottom surfaces of the N⁺-regions 5, 6) are adjusted and the hall voltage is detected by the N⁺-regions 5, 6, the symmetry of the resistance component in the current passage region (magnetic detector) A1 (wheatstone bridge) can be enhanced.

As described above, the hall element shown in FIGS. 1, 2 and 3 is completed, and the insulating layer 9 for regulating the current passage region A1 can be disposed.

Silicon oxide is used as the insulating layer 9. However, the insulating layer is not limited to silicon oxide. For example, silicon nitride may also be used.

### Second Embodiment

Next, a second embodiment will be described by focusing on the difference from the first embodiment.

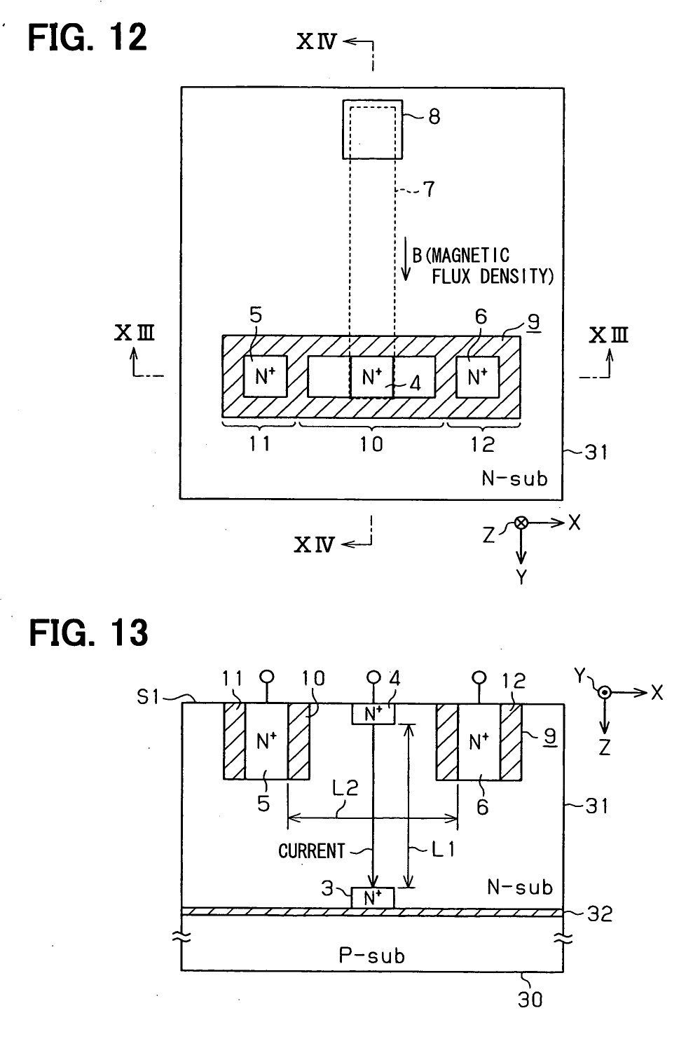

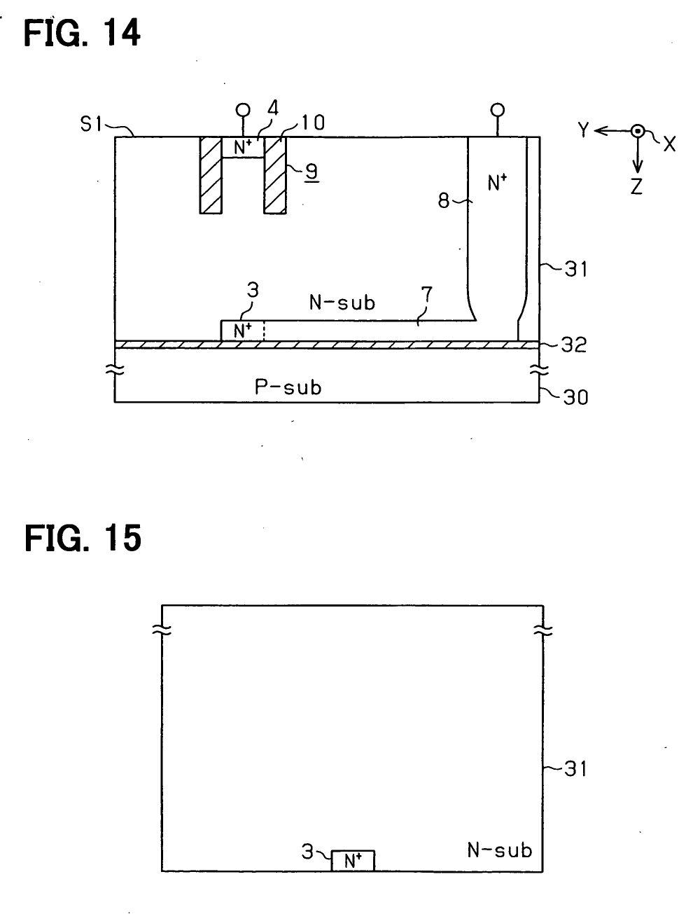

FIG. 12 is a plan view at a place where a hall element of a hall IC of the second embodiment is formed. FIG. 13 is a cross-sectional view of XIII-XIII of FIG. 12, and FIG. 14 is a cross-sectional view of XIV-XIV of FIG. 12.

In the first embodiment, the base substrate (1) on which epitaxial growth is carried out is used as the substrate. However, in place of this substrate, an N-type silicon substrate 31 is attached onto a P-type silicon substrate 30 through silicon oxide film 32 as shown in FIGS. 13, 14, and the substrate thus formed is used as the substrate. The other construction is the same as the first embodiment, and the same elements are represented by reference numerals. The description thereof is omitted.

Next, a manufacturing method will be described with reference to FIGS. 15 to 21. FIGS. 15 to 21 are longitudinally sectional diagrams showing the site corresponding to FIG. 13 (XIII-XIII of FIG. 12).

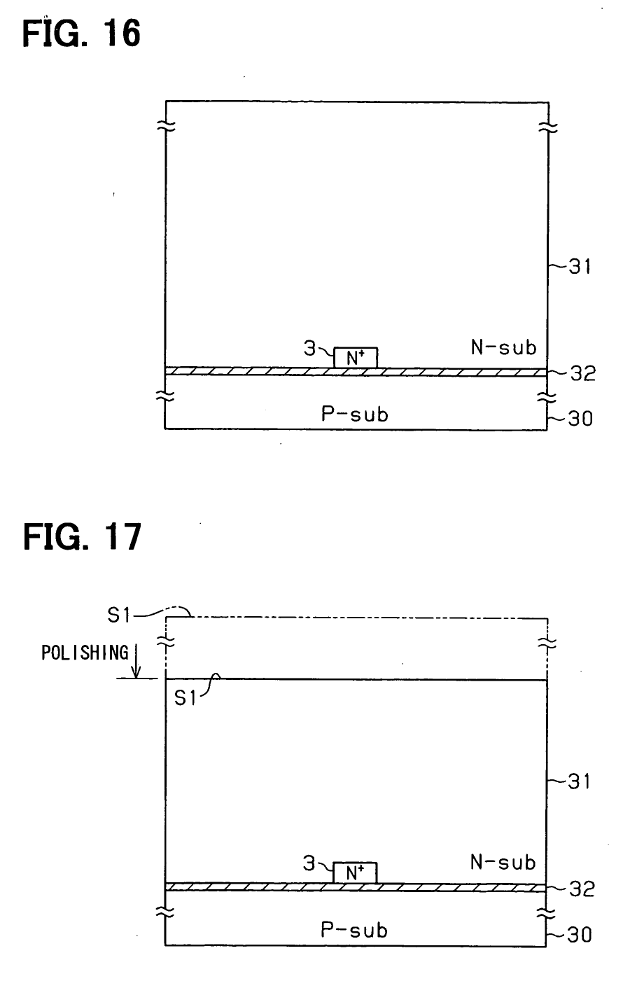

As shown in FIG. 15, an N-type silicon substrate 31 is prepared as the semiconductor substrate, and the N⁺-region 3 and the N⁺-region 7 (see FIG. 14) are formed on the surface of the N-type silicon substrate 31 (first step). As shown in FIG. 16, a surface of the N-type silicon substrate 31 on which the N⁺-region 3 is formed, and the P-type silicon substrate 30 of the base substrate are attached to each other through silicon oxide film 32 (second step).

Furthermore, as shown in FIG. 17, the principal surface S1 of the N-type silicon substrate 31 is polished and thinned (third step).

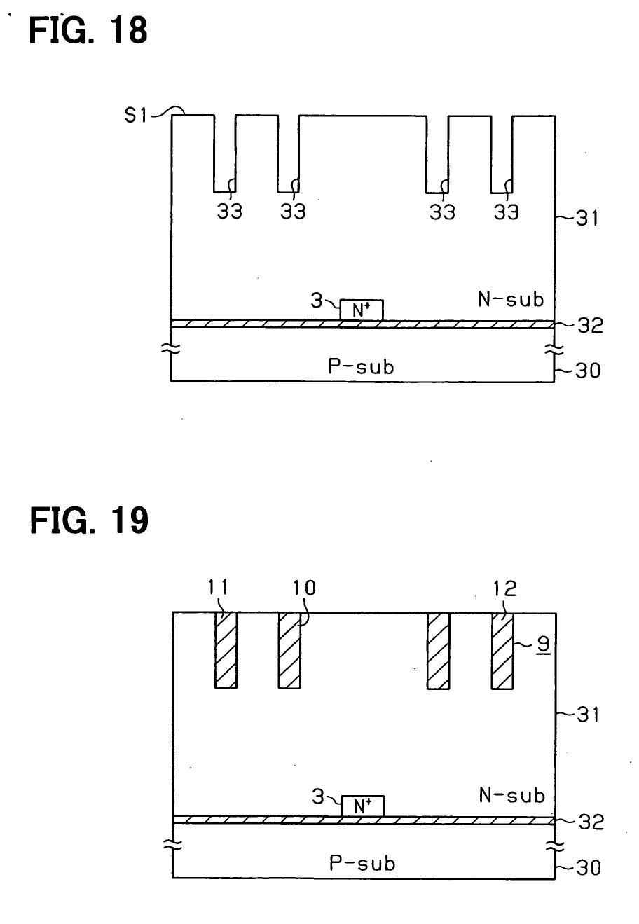

As shown in FIG. 18, insulating-layer burying trenches 33 are formed in the arrangement area of the insulating layer 9 in FIG. 12 of the principal surface S1 of the N-type silicon substrate 31, that is, around each formation-planed site of the N⁺-region 4, the N⁺-region 5 and the N⁺-region 6 (fourth step). Then, as shown in FIG. 19, the insulating layer 9 of SiO₂ (the rectangular frame portions 10, 11, and 12) is buried in the trenches 33 (fifth step). Thereafter, the surface of the N-type silicon substrate 31 is flattened.

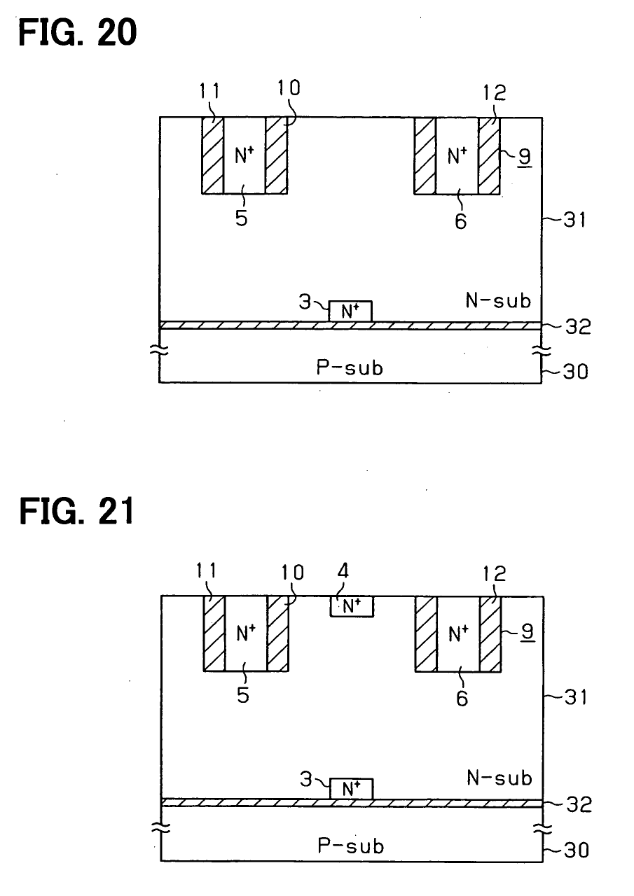

Subsequently, as shown in FIGS. 20 and 21, the N⁺-region 5 and the N⁺-region 6 are formed in the N-type silicon substrate 31 so that the side surfaces thereof are in contact with the insulating layer 9, and also the N⁺-region 4 is formed (sixth step). Specifically, as shown in FIG. 20, the N⁺-regions 5 and 6 are formed at the same depth as the rectangular frame portions 11 and 12 by conducting ion-implantation on the surface portion of the area surrounded by the rectangular frame portions 11 and 12 in the N-type silicon substrate 31. Furthermore, as shown in FIG. 21, the N⁺-region 4 is formed by conducting ion-implantation on the surface portion of the area surrounded by the rectangular frame portion 10 in the N-type silicon substrate 31. In FIGS. 20 and 21, the N⁺-regions 5 and 6 are formed to be deeper than the N⁺-region 4. Furthermore, the N⁺-region 8 of FIG. 14 is also formed.

Here, the N⁺-regions 5 and 6 can be formed at proper depths by adjusting the ion implantation energy when the N⁺-regions 5 and 6 are formed. That is, the contact positions thereof with the N-type epitaxial layer 2 (the positions of the bottom surfaces of the N⁺-regions 5, 6) at the bottom surfaces thereof exposed from the insulating layer 9 can be adjusted by adjusting the depths of the N⁺-regions 5, 6. When the contact positions (the positions of the bottom surfaces of the N⁺-regions 5, 6) are adjusted and the hall voltage is detected by the N⁺-regions 5 and 6, the symmetry of the resistance component (wheatstone bridge) in the current passage region (magnetic detector) A1 can be enhanced.

As described above, the hall element shown in FIGS. 12, 13 and 14 is completed, and the insulating layer, for regulating the current passage region A1 can be disposed.

The first embodiment uses the substrate comprising the P-type silicon substrate 1 and the N-type epitaxial layer 2 formed thereon as shown in FIG. 2. However, the second embodiment uses the substrate achieving by attaching the substrate 30 and the substrate 31. However, the substrate is not limited to the above implementations. For example, the substrate may have such a construction that only one silicon substrate is used, and the N⁺-regions 4, 5, and 6 are formed on one surface (principal surface S1) of the substrate while the N⁺-region 3 is formed on the other surface (back surface).

### Third Embodiment

Next, a third embodiment will be described with reference to the accompanying drawings.

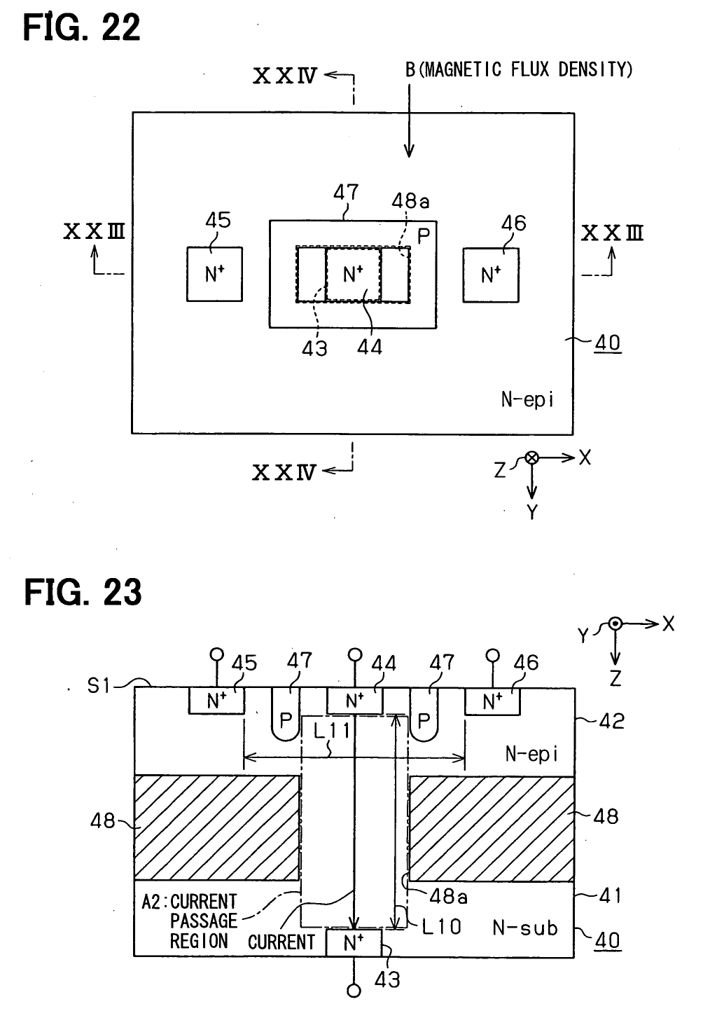

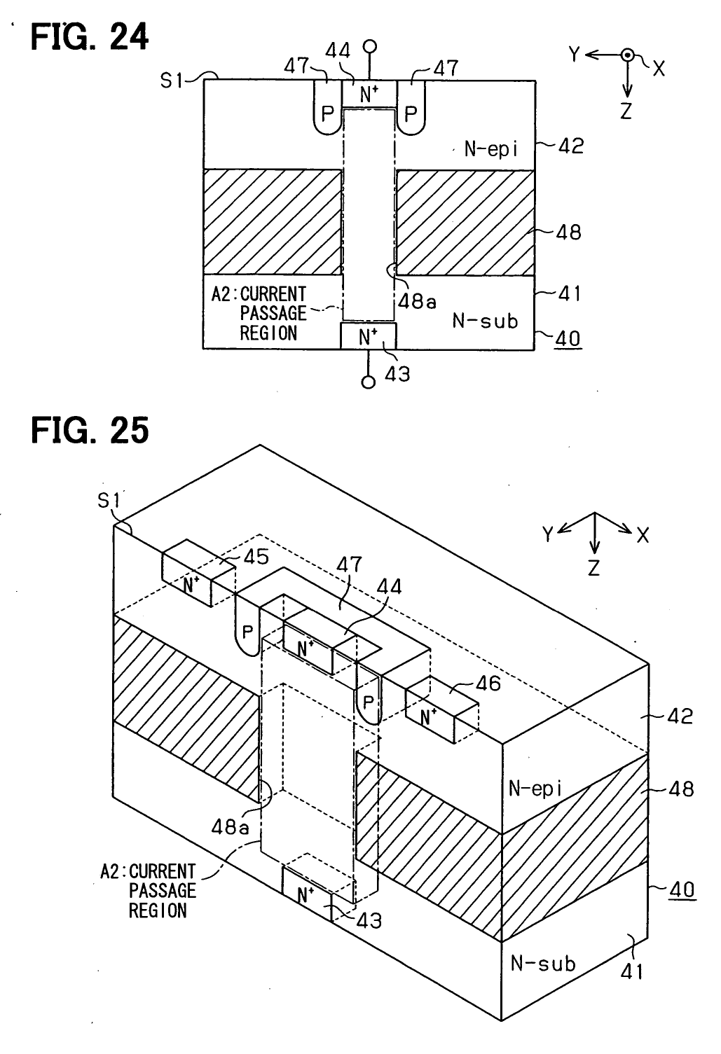

FIG. 22 is a plan view at a place where a hall element of a hall IC according to this embodiment is formed. FIG. 23 is a cross-sectional view taken along XXIII-XXIII of FIG. 22. FIG. 24 is a cross-sectional view taken along XXIV-XXIV of FIG. 22. FIG. 25 is a perspective view at the cross-section of XXIII-XXIII of FIG. 22.

A substrate 40 of this embodiment comprises an N-type silicon substrate 41 and an N-type epitaxial layer 42 formed thereon (see FIG. 30 showing a manufacturing process described later). As a semiconductor substrate, N⁺-regions 43, 44, 45, and 46 are formed as four electrode diffusion regions in the substrate 40.

Specifically, an N⁺-region 43 as a first electrode diffusion region is formed at the lower surface of the N-type silicon substrate 41, that is, at a predetermined depth position from the principal surface S1 of the substrate 40. Furthermore, an N⁺-region 44 as a second electrode diffusion region is formed on the principal surface S1 of the substrate 40 (the upper surface of the N-type epitaxial layer 42). The N⁺-region 43 and the N⁺-region 44 are formed to be overlapped with each other in the thickness direction of the substrate (in the Z-axis direction). The N⁺-region 43 and the N⁺-region 44 are formed to have the same shape and the same dimension. Furthermore, an N⁺-region 45 as a third electrode diffusion region and an N⁺-region 46 as a fourth electrode diffusion region are formed in the right-and-left direction (X-axis direction) so as to sandwich the N⁺-region 44 therebetween. More specifically, the N⁺-region 45 and the N⁺-region 46 are disposed to be positionally symmetrical with each other with respect to the N⁺-region 44 in FIG. 22.

Furthermore, a P-type region (the diffusion region having the opposite conductivity type to that of the substrate 40) 47 is formed around the N⁺-region 44 on the principal surface S1 of the substrate 40. The P-type region 47 is designed in a rectangular frame shape as shown in FIG. 22 in plan view, and specifically it is designed in an oblong shape having a longer side in the right-and-left direction (X-axis direction). The N⁺-region 44 is located at the center portion of the P-type region 47 having the rectangular frame shape. The P-type region 47 has a predetermined depth as shown in FIGS. 23 and 24, and it is formed from the upper surface of the N-type epitaxial layer 2 to be deeper than the N⁺-region 44.

The current passage region A2 formed between the N⁺-region 43 and the N⁺-region 44 is regulated by the P-type region 47, whereby the current passage region A2 is prevented from spreading and diffusion of electrons is suppressed. As a result, the current density is increased, and the sensitivity of the hall element is enhanced.

Furthermore, an insulating layer 48 for regulating the current passage region A2 is buried at a site deeper than the P-type region 47 in the substrate 40, specifically in the N-type silicon substrate 41 below the N-type epitaxial layer 42. That is, the insulating layer 48 is formed with the current passage region A2 as a through hole 48a. Silicon oxide is used as the insulating layer 48. The insulating 48 prevents the spreading of the current passage region A2 and thus suppresses the diffusion of electrons. As a result, the current density is increased, and thus the sensitivity of the hall element is enhanced.

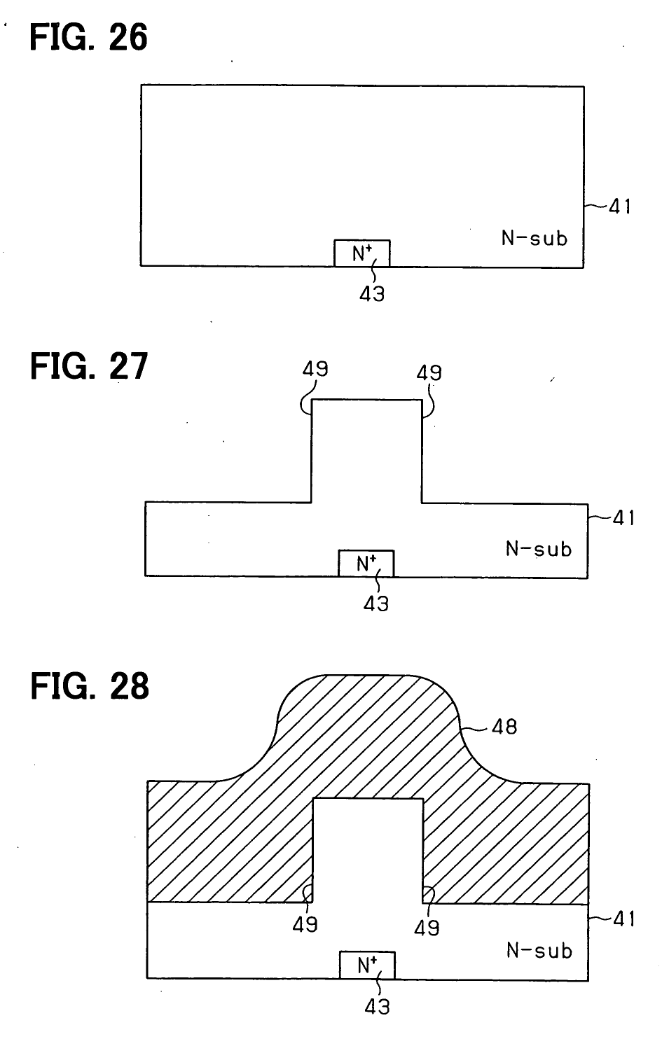

Next, the manufacturing method will be described with reference to FIGS. 26 to 32. FIGS. 26 to 32 are longitudinally sectional views at the site corresponding to FIG. 23 (XXIII-XXIII of FIG. 22).

First, as shown in FIG. 26, the N-type silicon substrate 41 is prepared as the semiconductor substrate, and the N⁺-region 43 is formed on the surface of the N-type silicon substrate 41 (first step). As shown in FIG. 27, trenches 49 are formed around the site serving as the current passage region A2 formed between the N⁺-region 43 and the N⁺-region 44 on the opposite surface to the surface of the N-type silicon substrate 41 on which the N⁺-region 43 is formed (second step).

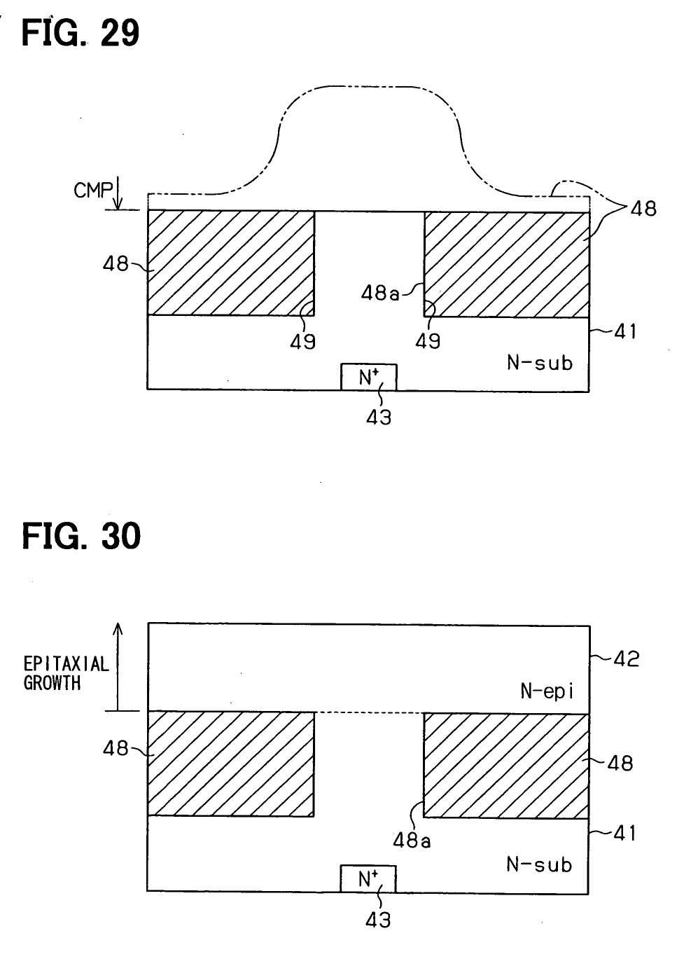

As shown in FIG. 28, an insulating layer 48 of SiO₂ is deposited on the substrate 41, and filled in the trenches 49 (third step). Thereafter, as shown in FIG. 29, the insulating layer 48 is polished by CMP or the like, and the substrate 41 is exposed (fourth step).

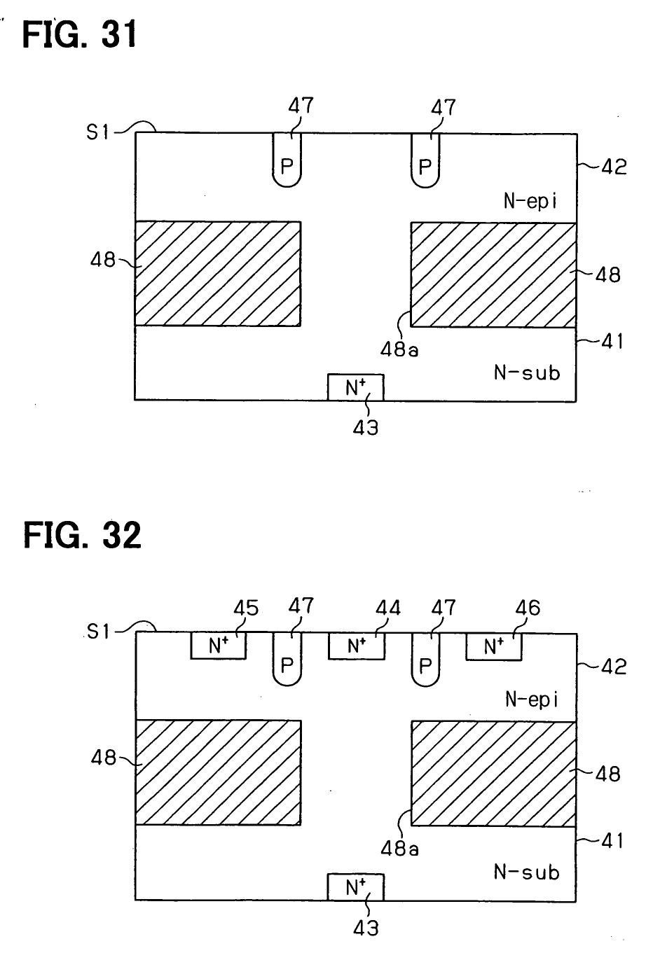

Subsequently, as shown in FIG. 30, the N-type epitaxial layer 42 is formed on the N-type silicon substrate 41 (fifth step). Furthermore, as shown in FIGS. 31, and 32, the N⁺-regions 44, 45 and 46 and the p-type region (a diffusion region having the opposite conductivity type to that of the epitaxial layer 42) 47 that is provided around the N⁺-region 44 and regulates the current passage region A2 are formed on the principal surface S1 of the epitaxial layer 42 (sixth step). Specifically, as shown in FIG. 31, the P-type region 47 is formed by conducting ion implantation on the surface portion of the epitaxial layer 42. As shown in FIG. 32, the N⁺-regions 44, 45 and 46 are formed by conducting ion implantation on the surface portion of the epitaxial layer 42.

As described above, the hall element shown in FIGS. 22, 23, and 24 is completed, and the insulating layer 48 and the P-type region 47 for regulating the current passage region A1 can be disposed.

This embodiment also carries out the chopper driving operation as described with reference to FIG. 5. In this case, in this embodiment, the distance L10 between the N⁺-region 43 and the N⁺-region 44 is equal to the distance L11 between the N⁺-region 45 and the N⁺-region 46 (L10=L11) as shown in FIG. 23. More specifically, the distance L10 between the confronting faces of the N⁺-regions 43 and 44 is equal to the minimum distance L11 between the side surface of the N⁺-region 45 and the side surface of the N⁺-region 46. Accordingly, the distance between the current electrodes and the distance between the voltage electrodes are equal to each other, and the offset cancel effect based on the chopper driving operation can be efficiently achieved.

Silicon oxide is used as the insulating layer 48. However, the insulating layer is not limited to silicon oxide, and silicon nitride may be used.

In the first to third embodiments, silicon is used as the material of the semiconductor substrate. However, the material is not limited to silicon, and GaAs, InAs, InSb or the like may be used.

Furthermore, with respect to the conductivity type in the first to third embodiments, the conductivity type of P-type, N-type may be inverted to each other.

What is claimed is:

1. A hall element comprising:
a first electrode diffusion region formed at a predetermined depth position of a semiconductor substrate;
a second electrode diffusion region and third and fourth electrode diffusion regions that are formed on a principal surface of the semiconductor substrate so that the second electrode diffusion region is sandwiched between the third and fourth electrode diffusion regions; and
an insulating layer formed at a predetermined depth around the second electrode diffusion region, around the third electrode diffusion region and around the fourth electrode diffusion region on the principal surface of the semiconductor substrate, wherein a current passage region formed between the first electrode diffusion region and the second electrode diffusion region is regulated by the insulating layer, and side surfaces of the third and fourth electrode diffusion regions are coated by the insulating layer so that the third and fourth electrode diffusion regions are brought into contact with the semiconductor substrate at bottom surfaces thereof exposed from the insulating layer.

2. The hall element according to claim 1, wherein the insulating layer, the third electrode diffusion region and the fourth electrode diffusion region (6) are formed to be deeper than the second electrode diffusion region.

3. A hall element comprising:
a first electrode diffusion region formed at a predetermined depth position of a semiconductor substrate;
a second electrode diffusion region and third and fourth electrode diffusion regions that are formed on the principal surface of the semiconductor substrate so that the second electrode diffusion region is sandwiched between the third and fourth electrode diffusion regions;
a diffusion region having the opposite conductivity type to that of the semiconductor substrate is formed at a predetermined depth around the second electrode diffusion region on the principal surface of the semiconductor substrate to regulate a current passage region formed between the first electrode diffusion region and the second electrode diffusion region by the diffusion region; and
an insulating layer for regulating the current passage region is buried in a deeper site than the diffusion region having the opposite conductivity type in the semiconductor substrate.

4. The hall element according to claim 3, wherein the distance between the first electrode diffusion region and the second electrode diffusion region is equal to the distance between the third electrode diffusion region and the fourth electrode diffusion region.

5. The hall element according to claim 1, wherein the distance between the first electrode diffusion region and the second electrode diffusion region is equal to the distance between the third electrode diffusion region and the fourth electrode diffusion region.

6. A method of manufacturing a hall element comprising a first electrode diffusion region formed at a predetermined depth position of a semiconductor substrate, and a second electrode diffusion region and third and fourth electrode diffusion regions that are formed on a principal surface of the semiconductor substrate so that the second electrode diffusion region is sandwiched between the third and fourth electrode diffusion regions, the method comprising:
forming an epitaxial layer on a semiconductor substrate, the epitaxial layer having opposite conductivity type to that of the semiconductor substrate, the epitaxial layer being formed under a state that the first electrode diffusion region is buried at an interface portion;
forming insulating-layer burying trenches around each formation-planed site of the second electrode diffusion region, third electrode diffusion region and fourth electrode diffusion region on a principal surface of the epitaxial layer;
burying an insulating layer in the insulating-layer burying trenches; and
forming the third electrode diffusion region and the fourth electrode diffusion region in the epitaxial layer so that side surfaces of the third and fourth electrode diffusion regions are brought into contact with the insulating layer and also forming the second electrode diffusion region.

7. A method of manufacturing a hall element comprising a first electrode diffusion region formed at a predetermined depth position of a semiconductor substrate, and a second electrode diffusion region and third and fourth electrode diffusion regions that are formed on a principal surface of the semiconductor substrate so that the second electrode diffusion region is sandwiched between the third and fourth electrode diffusion regions, the method comprising:
forming the first electrode diffusion region on a surface of the semiconductor substrate;
attaching a base substrate to the surface of the semiconductor substrate on which the first electrode diffusion region is formed through an oxide film;
polishing the principal surface of the semiconductor substrate to thereby thin the semiconductor substrate;
forming insulating-layer burying trenches around each formation-planed site of the second electrode diffusion region, the third electrode diffusion region and the fourth electrode diffusion region on the principal surface of the semiconductor substrate;
burying an insulating layer in the insulating-layer burying trenches; and
forming the third electrode diffusion region and the fourth electrode diffusion region so that side surfaces thereof are brought into contact with the insulating layer.

8. A method of manufacturing a hall element comprising a first electrode diffusion region formed at a predetermined depth position of a semiconductor substrate, and a second electrode diffusion region and third and fourth electrode diffusion regions that are formed on a principal surface of the semiconductor substrate so that the second electrode diffusion region is sandwiched between the third and fourth electrode diffusion regions, the method comprising:
forming the first electrode diffusion region on a surface of a semiconductor substrate;
forming a trench around a site serving as a current passage region formed between the first electrode diffusion region and the second electrode diffusion region to be formed on an opposite surface to the surface of the semiconductor substrate on which the first electrode diffusion region is formed;
depositing an insulating layer on the semiconductor substrate to fill the trench with the insulating layer;
polishing the insulating layer to expose the semiconductor substrate;
forming an epitaxial layer on the semiconductor substrate; and
forming the second electrode diffusion region, the third electrode diffusion region, the fourth electrode diffusion region and a diffusion region around the second electrode diffusion region, the diffusion region having opposite conductivity type to that of the epitaxial layer and regulating the current passage region.
